(19) United States
(12) Patent Application Publication
(10) Pub. No.: US 2014/0223520 A1
(43) Pub. Date: Aug. 7, 2014

(54) GUARDIAN CONTROL OVER ELECTRONIC ACTIONS

(71) Applicant: SECUREPUSH LTD., Nahariya (IL)

(72) Inventor: Guy GAFNI, Moshav Ben-Ami (IL)

(73) Assignee: SECUREPUSH LTD., Nahariya (IL)

(21) Appl. No.: 14/249,683

(22) Filed: Apr. 10, 2014

Related U.S. Application Data
(63) Continuation-in-part of application No. 13/221,626, filed on Aug. 30, 2011.

(51) Int. Cl. H04L 29/06

(52) U.S. Cl. CPC H04L 63/107
USPC 726/4

(57) ABSTRACT

A method for guardian control over an electronic action includes registering one or more guardians and at least one mobile communication device associated with each guardian with an authorization module hosted on an authorization server. Each mobile communication device is identified by a unique hardware identification number. An authentication request for a supervised client that is attempting to perform the electronic action at a site is received by the authorization server from a site. A confirmation request is sent from the authorization server to the mobile communication device requesting the guardian to confirm the action. The action is authorized upon receiving confirmation from the mobile communication device.

### CROSS REFERENCE TO RELATED APPLICATIONS

This application is a continuation-in-part of U.S. patent application Ser. No. 13/221,626, entitled “Method and System for Authorizing an Action at a Site”, filed on Aug. 30, 2011, published as United States Patent Application Publication Number 2013/0055356-A1 on Feb. 28, 2013, and which is incorporated in its entirety herein by reference.

### FIELD OF THE INVENTION

The present invention relates to electronic actions. More particularly, the present invention relates to guardian control over electronic actions.

### BACKGROUND OF THE INVENTION

Present day information technology (IT) is characterized by an abundance of electronic sites that are available, accessible by users over public (e.g., the Internet) and private (e.g., local) networks.

A “site”, in the context of the present application, refers to any site that may be accessed by a user, such as, for example, an Internet site, an organizational management intranet system (e.g., Customer Relationship Management—CRM—system), a credit-card transaction approval system (e.g., remote systems, such as, for example, PayPal or local systems), an email box (e.g., Hotmail, Gmail etc), a bank account, an Automated Teller Machine (ATM) and so on. The “site” may include a remote computer, a remote computer network. The “site” may also include an mediator (software, hardware or a combination thereof), such as for example, a switch connected to a single or a plurality of devices, a router connected to a single or a plurality of devices and the like.

Some of these sites only provide access to information (e.g., general, public, private and confidential information), while other sites allow users to view information as well as perform an action.

The access to some sites is not limited, whereas other sites limit the access and require that certain conditions be met in order to allow a user to access the site. Typically, sites with limited access require some form of identification and authentication. In many cases a user is required to register to that site by selecting a user name and a password and, in many cases, other personal information depending on the particular site requirements. At a later time, the user name and password (or other information) may be provided in order to access that site or perform an action at that site.

In most cases, the access information that a user is required to provide in order to gain access to a site is simple and may easily be apprehended. For example, in order to successfully complete a credit-card transaction over a network e.g., the Internet), a buyer is usually required to provide a full name, an address, credit card number, expiry date (sometimes also a Card Verification value—CVV—number located on the back of the credit card). Such information may not be too hard to obtain (e.g., look over the shoulder of a person using a credit card or overhear a conversation in which this information is mentioned, or by having a Trojan Horse type virus (or other spy viruses) installed on the user's computer for sending all typed or stored information to a remote computer).

It is also known that many users (some even claim that this is true for the majority of users) tend to register in many sites using the same email, user name and password, or use very similar registration details by changing only one or a few letters or digits). Thus, if a user's name, password or email are unlawfully apprehended, many sites to which that user is registered may be illegally accessed by others disguising as that user. Such unlawful access may result in private information being exposed, fraud and other illegal actions that may cause extensive damages.

Sometimes it is one of the sites to which a user is registered that is hacked, and valuable personal information may be unlawfully retrieved and used for accessing other sites to which the user is registered.

Current authentication methods typically do not address the situation in which more than one person is required to confirm an action. For example, many businesses and organizations require that two (or more) persons authorize an action, such as when engaging in a legal contract, performing a financial transaction, performing an action in a bank account, etc. Strangely enough, to-date, executives of such businesses and organizations are allowed to charge their company's credit card or draw money from an ATM machine without another person authorizing their transaction just because technically the credit card company has no technology to support that requirement.

The need for a more secured authentication has brought about the use of additional authentication measures. Two-factor or multi-factor authentication methods were introduced that require the presentation of two or more Independent kinds of identity evidence.

Multi-factor authentication involves the use of two or more independent kinds of evidence to assert an entity, rather than two or more iterations of the same kinds. In essence, there are three independent means for establishing identity, which may be characterized as something the user knows (e.g., username, password, personal identification number—PIN), something the user has (e.g., a physical token, ID card, passport), and something the user is (e.g., biometric information, such as a fingerprint, retinal scan, face geometry).

It is generally accepted that any combination of these independent authentication means (e.g., password+value from a physical token) is multi-factor authentication.

Multi-factor authentication may include, inter-alia:

1. A designated security hardware component, which an authorized user is to use when connecting to a site. The hardware component is attached to the user's local machine or a hand-held machine (e.g., terminal, PC, PDA, smartphone, tablet), and includes authentication information pertaining to the user that the remote site requires, in addition to the regular login details the user is required to produce, in order to allow the user to gain access. Examples of such hardware component may include smart cards, fingerprint reader, USB plug, etc.

2. Some networks are designed to protect their users by offering a precluded space in which only select users, such as for example, VPN (Virtual Private Networks). Such networks allow only specific stations, devices or users identified in the network to access sites and services in that network.

3. Ciphering certificate protocols are also known (e.g., SSL certificates), which are installed on specific stations and on the remote site to confirm authorized access to the remote site by comparing the certificate from the station with the expected one on the site.

4. Sending confirmation messages with a unique code (e.g., SMS, email) to the user, confirming the execution of a transaction allegedly made by that user at the site by entering the sent code as a part of the regular login process.

5. Installing software on a second hardware device (like phone, smart USB keys, hardware devices like firewalls and routers) that generates random codes so that each time a user attempts to access a site, the generated code has to be used (manually or automatically input) during the access procedure, after providing the login details

6. Performing risk evaluation (typically used for credit-card transaction confirmations and money transfers) to calculate a risk level for that transaction in order to determine whether to authorize that transaction and execute it.

7. Human intervention (typically used for credit-card and banking transaction confirmations), which involves a human contacting the user to verify a specific transaction prior to its final confirmation, sometimes requiring additional authentication information (e.g., billing address, ID number and even send physical documents by fax or email, etc.).

### SUMMARY OF THE INVENTION

There is thus provided, in accordance with some embodiments of the present invention, a method for guardian control over an electronic action, the method including: registering one or more guardians and at least one mobile communication device associated with each guardian with an authorization module hosted on an authorization server, each of the at least one mobile communication device being identified by a unique hardware identification number; receiving by the authorization server an authentication request from a site for a supervised client that is attempting to perform the electronic action at the site; sending a confirmation request from the authorization server to the at least one mobile communication device requesting each guardian of the one or more guardians to confirm the action; and authorizing the action upon receiving confirmation from at least one device of the at least one mobile communication device that is associated with each the one or more guardians.

Furthermore, in accordance with some embodiments of the present invention, the method includes registering the site with the authorization module.

Furthermore, in accordance with some embodiments of the present invention, the method includes installing a dedicated application in the at least one mobile communication device.

Furthermore, in accordance with some embodiments of the present invention, the at least one mobile communication device includes a cellular telephone.

Furthermore, in accordance with some embodiments of the present invention, the cellular telephone includes a smartphone.

Furthermore, in accordance with some embodiments of the present invention, the method includes determining a location of the at least one mobile communication device and verifying that the location is within one or more predetermined zones.

Furthermore, in accordance with some embodiments of the present invention, the one or more predetermined zones include a zone within which the guardian with which that mobile communication device is associated is expected to be.

Furthermore, in accordance with some embodiments of the present invention, requesting each guardian to confirm the action or authorizing the action is subjected to a time limit.

Furthermore, in accordance with some embodiments of the present invention, the electronic action includes a purchase.

Furthermore, in accordance with some embodiments of the present invention, the site includes a website that is accessed by a local station.

Furthermore, in accordance with some embodiments of the present invention, the site includes a point of sale.

Furthermore, in accordance with some embodiments of the present invention, wherein the method further includes registering at least one client mobile device associated with the supervised client, each of the at least one client mobile device being identified by a unique hardware identification number; and sending a verification request from the authorization server to the at least one client mobile device; wherein authorizing the action is further conditioned upon receiving verification at least one device of the at least one client mobile device.

Furthermore, in accordance with some embodiments of the present invention, the verification request includes requesting a geographic location of the at least one client mobile device.

Furthermore, in accordance with some embodiments of the present invention, the method further includes comparing the geographic location with a location from which the electronic action was attempted.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a flowchart of a method for authenticating a user at a site, in accordance with embodiments of the present invention.

FIG. 2A illustrates registration of a user and his communication device to an authentication service, in accordance with embodiments of the present invention.

FIG. 2B illustrates authentication of a registered user attempting to perform an action at a site, in accordance with embodiments of the present invention.

FIG. 3 is a flowchart of a method for authorizing a single action by a plurality of users at a site, in accordance with embodiments of the present invention.

FIG. 4 illustrates a system for authorizing a single action by a plurality of users at a site, in accordance with embodiments of the present invention.

FIG. 5 illustrates authentication of a registered user attempting to access a remote network, in accordance with embodiments of the present invention.

FIG. 6 is a flowchart of a method for guardian control over an electronic action, in accordance with an embodiment of the present invention.

FIG. 7 schematically illustrates a system for guardian control over an electronic action at a remote site by a supervised client, in accordance with an embodiment of the present invention.

FIG. 8 schematically illustrates a system for guardian control over an electronic action by a supervised client at a point of sale, in accordance with an embodiment of the present invention.

FIG. 9 schematically illustrates a system for guardian control over an electronic action that includes verification by a supervised client, in accordance with an embodiment of the present invention.

### DETAILED DESCRIPTION OF THE INVENTION

Embodiments of the present invention, relating to single-factor, two-factor or multi-factor authentication method and system are presented herein.

The terms “authentication” and “authorization” and “identification” are practically interchangeable, in the context of the present invention.

An aspect of the present invention relates to the use of a personal communication device (typically a mobile communication device, but in some embodiments an immobile communication device may be used), which is capable of executing a software application or hardware, or a combination thereof, allowing a user to input information and/or commands. In some embodiments of the invention the communication device may be, for example, a cellular telephone, a smartphone, a smart device such as a tablet, IOS (iPhone operating system) based device, such as, iPod, iPad, iPhone, Android based device, windows based mobile device and other similar smart devices.

Another aspect of the present invention is the use of a unique hardware identification information, which uniquely identifies a personal communication device, such as, for example, a unique identification assigned to a personal communication device by a server (the operating system provider) using push technology, unique identification information associated with NFC (near field communication) hardware technology, MAC (media access control) address, IMEI number, UDID (unique device identifier), etc., in accordance with embodiments of the present invention.

According to some embodiments of the invention, there may be total separation of identity information between the communication device of the user and the site which the user is accessing. The association between the user and the site is solely performed and managed by an independent authentication server, which may employ various permanent and temporary verification keys. For many purposes, in accordance with some embodiments of the present invention, the authentication server would be a third party entity, separate from the user or the site or site owner. In some other embodiments, the authentication server may be located at the site or otherwise associated with the site or site owner. The authentication server may be implemented in hardware, software or a combination thereof.

Other aspects of the present invention involve making use of various capabilities of communication devices such as mobile telephones (e.g., smartphones), including communicating via a telecommunication carrier network, acquiring images and other capabilities.

Subscriber Identity Modules (SIM) are synonymous with mobile phones and devices that interoperate with cellular networks. A cellular phone is referred to as a Mobile Station and is partitioned into two distinct components: the Subscriber Identity Module (SIM) and the Mobile Equipment (ME). A SIM is a removable component that contains essential information about the subscriber. The ME, the remaining radio handset portion, cannot function fully without one. The SIM's main function is to authenticate the user of the cell phone to the network in order to gain access to subscribed services.

Moving a SIM between compatible cell phones automatically may transfer with it the subscriber's identity and the associated information and capabilities. While SIMs are most widely used in cellular systems, comparable modules are also used in iDEN phones and UMTS user equipment (i.e., a USIM). Because of the flexibility a SIM offers cellular phone users to port their identity, personal information, and service between devices, eventually all cellular phones are expected to include (U)SIM-like capability. For example, requirements for a Removable User Identity Module (R-UIM), as an extension of SIM capabilities, have been specified for cellular environments conforming to TIA/EIA/IS-95-A and -B specifications, which include Wideband Spread Spectrum based CDMA.

However, typically all GSM, WCDMA, and iDEN mobile telephone handsets have a unique hardware identification information—e.g., a unique identification assigned to a personal communication device by a server using push technology, unique identification information associated with NFC (near field communication) technology, MAC (media access control) address, IMEI number, UDID (unique device identifier), etc.—which distinctly identifies each handset. The IMEI number is used, for example, to identify valid devices and therefore can be used for stopping a stolen phone from accessing the network in that country.

Another aspect of the present invention is the provision and management of a method for authentication of a user for allowing the performance of an action by that user at a site, using a third party authentication server to which both the user and the site must be registered.

According to some embodiments of the present invention, the user who has in his or hers (hereinafter, for brevity—his) possession a communication device first registers to the authentication service. This may be carried out, for example, by installing a dedicated application on the communication device which is designed, when executed, to request the user to provide basic identification information (e.g., username and password) and send to the authentication server the basic identification information as well as a unique identification information associated with the hardware of the communication device (e.g., unique identification information associated with a push service, NFC, MAC address, UDID, IMEI etc.). In some embodiments of the invention, more than one form of unique identification information, associated with the hardware of the communication device, may be used for added safety.

For many purposes it would seem that using unique hardware identification information associated with push services would be a very good choice, as push services (e.g., push services provided by Apple, Google, Microsoft or other reputable operating system vendors) appear to be very secured. This means that if a replica is made of a personal communication device (e.g., a smartphone, tablets), although all its hardware components would appear to be identical, the replica would not pass as identical in a push service, and only the original smartphone would continue to receive the push service.

According to some embodiments of the invention, the authentication server assigns the user a unique user key for use when communicating with the site, with which that user is associated at the authentication server. This is to avoid exposing the real unique identification information of the communication device when the server is communicating with the outside world.

The site registers with the authentication server too by providing site identification information (e.g., one or more of the following identification details: site name, site description, unique IP address, domain name etc.). The authentication server assigns that site a unique connection key. According to some embodiments of the invention, the authentication server may provide a proxy file which is suited for use on that site (according to the development environment of that site) which facilitates working with cross-domain technology, as will be explained hereinafter.

Next, the user may register to the site. The registration to that site may be carried out in the regular manner which that site requires. Typically such registration requires the user to provide basic identification information (e.g., name, address, user name, age, ID number, etc.), which is not necessarily (and in fact it is recommended that it is different from) the identification information which the user had provided to the authentication server in the process of registering to the authentication server using the dedicated application.

In the registration process of the user to the site, when the user chooses to use the authentication method according to the present invention, or if the site requires that, the site requires the user to associate his communication device with that site. This may be accomplished, for example, by presenting to the user site data that includes the unique site key which was assigned to it by the authentication server in the process of registration of the site to the server, and which has to be acquired using the communication device. Once the communication device has acquired the site data it is communicated by the dedicated application to the authentication server. The authentication server then associates the communication device of the user (and the user) to the site and generates a common communication key which is saved by the site and from that time on is used by the site when dealing with the user through the authentication server.

Next time, when the user attempts to access the site, the site sends the common communication key to the authentication server and the authentication server, which knows the actual real unique identification information of the communication device, sends to the appropriate communication device a confirmation request. (e.g., as push message) The holder of the communication device—which is presumably the authorized user—is prompted by the dedicated application to confirm the request. That conformation is communication by the dedicated application on the communication device to the authentication server, and the server, upon verifying that the communication device is indeed associated with that user authenticates that user to the site. Upon receiving this authentication the site allows the user access or performance of an action in that site.

In some embodiments of the invention, the use of temporary keys (e.g., unique identifiers) which are time limited may be involved so as to increase security.

Using the authentication method according to some embodiments of the present invention reduces the risk of security breach by creating the need for independent identity verification both form the site and the user by a third party.

According to some embodiments of the invention, the user may, at any time, replace his registered communication device by registering another communication device. When the new device is registered the previously registered device becomes unregistered.

In other embodiments of the invention, the user may register a plurality of communication devices, or add new communication devices to the one already registered. In some embodiments, the user may use either one of his registered communication device for the authentication action. In some other embodiments, the user may be required, or choose, to use two or more of his registered communication devices for a single authentication action.

The mobile equipment unique identity information may be, for example, unique identification information associated with a push service, NFC unique identification information, MAC address, UDID, IMEI number, etc.

According to some embodiments of the present invention, the mobile equipment unique identity information may be obtained automatically, without the intervention of a human user. This may be accomplished, for example, by installing a designated application on the personal communication device which is designed, when executed, to access the mobile equipment unique identity information embedded in the personal communication device (also referred to, in the present application, as “the handset”) and forward it at a first instance for registration, and at later instances for verification.

According to some embodiments of the present invention, an authentication service may be provided, for facilitating authentication of a user attempting to access a remote site.

In some embodiments of the present invention, the authentication service may be administered by an authentication entity which is independent from the user or from the site. For example, the authentication entity may be embodied in the form of an authentication module, which is designed to communicate with the site and with the user over one or more communication networks (e.g., the Internet, mobile communication network)

According to some embodiments of the invention, a user may register to the authentication service provided by the authentication module by installing a designated application (hereinafter referred to as “the application”) on a personal communication device (hereinafter referred to, for brevity, as “the handset”) which is at the user's disposal. In some embodiments of the present invention, it may be required that the handset be in the possession of that user or that the user be a registered user of the handset.

At an initial instance, the application, when executed, may allow the user to register to the service by providing personal identification information (e.g., username, password, email address). At the registration instance, the application may assign the handset with one or more security keys. Said one or more security keys, according to some embodiments of the present invention, may comprise, for example, a first key that includes mobile equipment identity information which is unique to each handset (and thus allowing distinction between different handsets). In some embodiments of the invention, the security keys may also include a second unique key which is uniquely assigned to that handset. Registration information of the handset (e.g., its uniquely associated security keys) may be saved and accessed by the authentication module, associating it with the user. According to some embodiments of the present invention, the registration of the handset may be performed using a communication connection between the handset (e.g., over the Internet, using a cellular communication network for accessing the Internet).

Independently of the registration of the user, a site operator may register the site to an authentication service, according to some embodiments of the present invention. In the registration process of the site, it is provided with one or more security keys, for example, a site token and connection token. The site token may be designed to identify an owner or operator of the site. In some embodiments of the invention, the owner or operator of the site may be linked to more than one site for the authentication service. The connection key may be used to uniquely identify the specific site.

According to some embodiments of the present invention, the site may also be provided with a computer executable code which includes the tokens and is designed to conform to the operation environment of the site. The site may also be provided with a proxy code (file) facilitating a cross-domain operation. The code may then be incorporated in the site (e.g., at the registration page and at the login page of the site).

A user may access remote sites using a station (e.g., terminal, PC) which may communicate with the site over a communication network (e.g., the Internet). When the user wishes to register to a remote site which is registered to the authentication service, according to some embodiments of the present invention, the site may require an initial registration process that involves associating the user with personal identification information (e.g., username, password, which may be different that the personal identification information associated with that user at the authentication module). During the registration process of the user to that site, the site generates a call to the authentication module to present the user with user security keys, e.g., displaying it to the user on a display device of the user (locally, at the user's station) in a separate window (e.g., employing cross-domain technology, activated by the proxy code). The security codes may include the security codes that were assigned to the site by the authentication module (e.g., the site token and the connection token) as well as a third security code—attach key. The third code is designed to uniquely offer to the handset, validating the connection with the handset of the user. Typically, the third code (the attach code) is a temporary code valid for a short period of time. The short period of time may be, for example, the time the cross-domain window is displayed to the user. Each time the cross-domain window is displayed a different attach key is generated.

The three security codes presented in the cross-domain window may be provided in the form of a barcode. The barcode may be, for example, a one-dimensional bar-code (e.g., linear barcode) or two-dimensional barcode (matrix barcode, such as, for example Quick-Response—QR—code.

According to some embodiments of the invention, the user may point the camera of the handset to the barcode in the cross-domain window and acquire an image of the barcode. For example, the application may prompt the user to aim the camera of the handset towards the screen and the acquisition of the image is performed automatically when the camera is found to point at the barcode. Alternatively, the user may be prompted to activate the camera and acquire the image of the barcode.

Embedding the three keys in a barcode allows hiding the keys from preying eyes and may be preferred, but in some embodiments of the present invention the keys may be presented unhidden so that the user may input them into the smartphone manually. Other forms of graphical presentation may also be possible, which involve acquiring an image by the handset's camera and extracting the key information using image processing (e.g., OCR).

The application extracts the three codes from the barcode and communicates the retrieved codes to the authentication module, for associating the handset with the site. If the three communicated keys are found valid at the time they are received at the authentication module, the user, with the user's handset are associated with the site, and a forth key—secret token is generated by the authentication module. The authentication module communicates to the site two keys—the attach token and the secret token, which are saved at by the site and are associated with the user in the registration record for that user, for future reference, next time the user attempts to access the site.

The use of an additional forth code (secret code) may be advantageous as the third code (the attach code) remains for a substantially long time in the memory of the station during the registration process, and malicious spyware may apprehend this code and manipulate the application to confirm an action. To prevent this from happening, in accordance with embodiments of the invention, the forth code (key) (the secret code (key)) may be generated and communicated to the site just before the cross-domain window is closed (e.g., 0.01 second before the cross-domain window is closed), so as to eliminate, or at least greatly reduce the risk of apprehension of the code (key) by a third-party malicious code.

The next time the user, who has registered to site using the authentication service in accordance with some embodiments of the present invention, visits the site, and after providing the personal identification information with which the user is registered at that site (to perform login), the site issues an authentication request to the authentication module which includes the two security keys that were assigned to the site at the registration of the site to the service (e.g., the site token and the connection token) and the attach token which is associated with the identified user in the registration record of that user at the site. The authentication module, in turn, generates a confirmation request which includes a temporary confirmation key that is communicated to the handset. The use of the temporary confirmation key facilitates that only the authentication module knows which site and user require authentication for that particular action, whereas the site has no knowledge of the mobile equipment identity information of the handset.

The application running on the handset may then prompt the user to confirm the action by inputting a confirmation command, for example, by presenting a confirmation screen (e.g., Push Message) and requiring the user to press a key or otherwise operate the handset so as to make the application receive the confirmation command.

If the user inputs a confirmation command into the handset, a confirmation message may then be communicated to the authentication module, which in turn sends the secret token corresponding to the attach token that was sent by the site in the authentication request. The confirmation proxy screen is then closed and the authentication module may send the secret token of the user to the site for verification against the registration information of that user at the site.

Without the user confirming the action using the handset, the action is not authorized to the site by the authentication module.

While the process described hereinabove referred to authentication of a user attempting to access a site, it should be understood that an authentication method (and corresponding system), in accordance with some embodiments of the present invention, may be used in connection with various kinds of actions that require authentication (e.g., accessing a site, retrieving confidential information from a site, performing a transaction, charging a credit card, etc.)

Reference is now made to the figures.

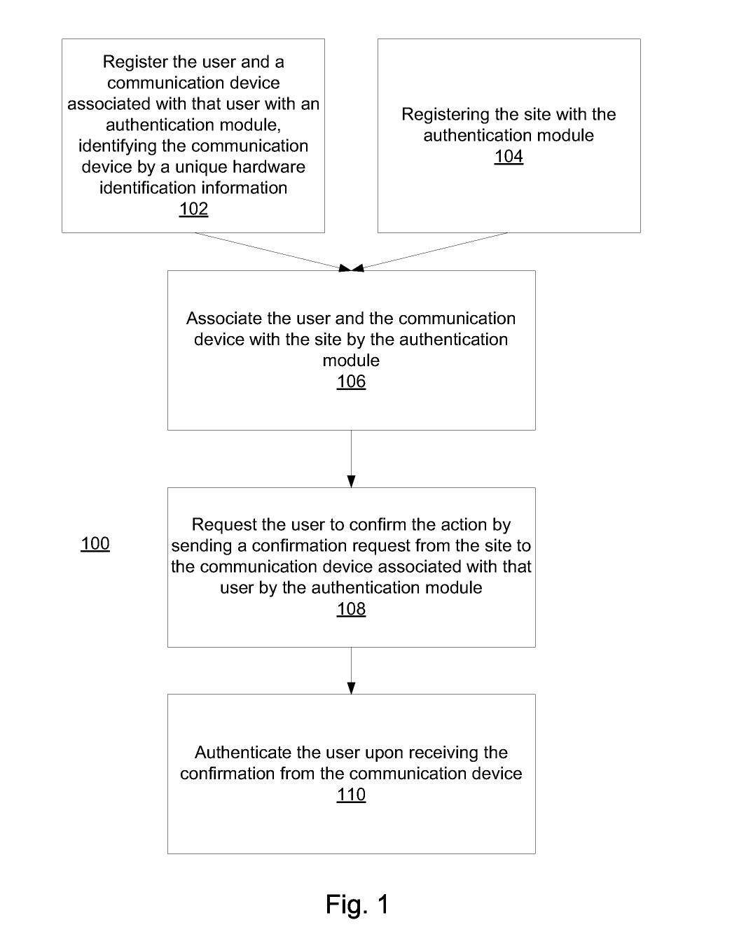

FIG. 1 is a flowchart of a method 100 for authenticating a user at a site, in accordance with embodiments of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Method 100 may include registering 102 the user and at least one communication device associated with that user with an authentication module, identifying each of said at least one communication devices by a unique hardware identification information, and registering 104 the site with the authentication module. The order of registration may not be important.

Method 100 may further include associating 106 the user and his (or hers) one or more communication devices with the site by the authentication module. This means that the association between the user and his communication device is known to the authentication module. Method 100 may also include requesting 108 the user to confirm the action by sending a confirmation request from the site to the communication device associated with that user by the authorization module, and authorizing 110 the user to the site upon receiving the confirmation from said at least one communication devices.

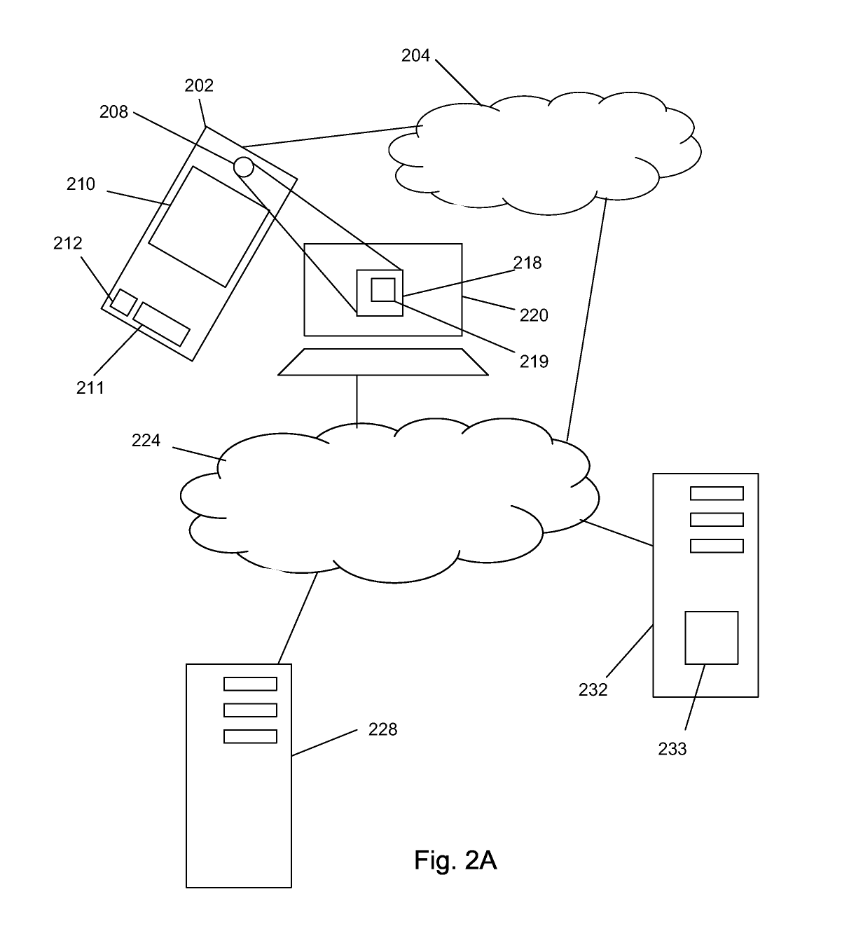

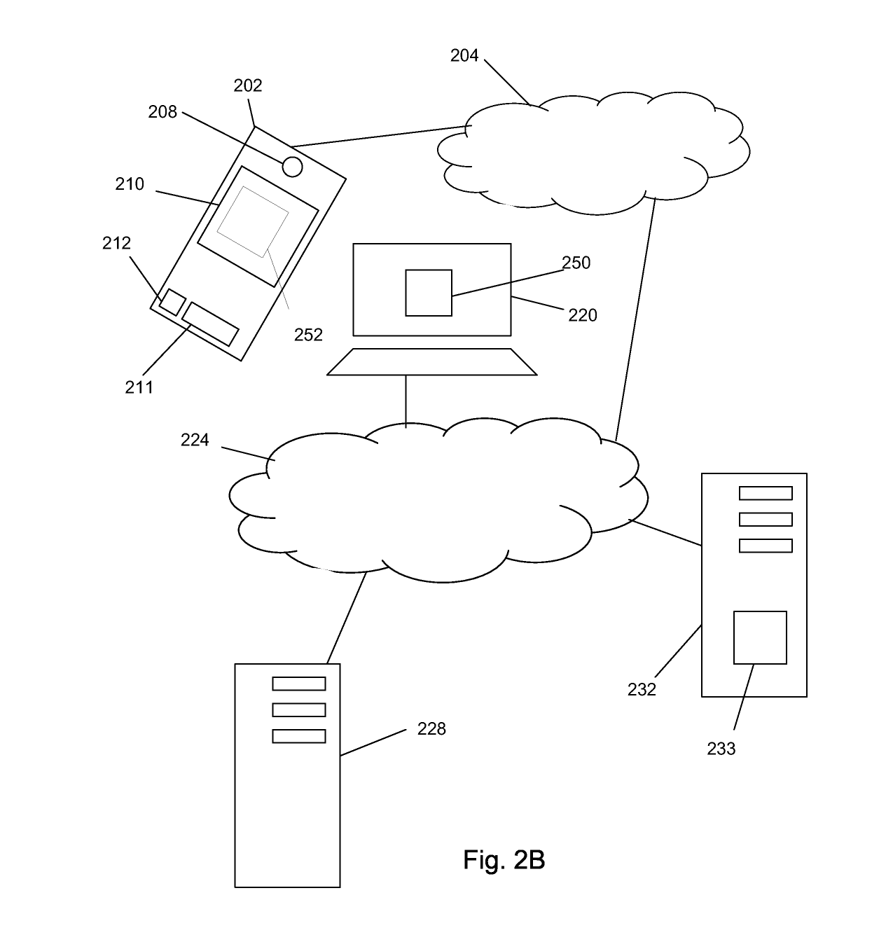

FIG. 2A illustrates registration of a user and his communication device to an authentication service, in accordance with embodiments of the present invention.

An owner or operator of site 233 (hereinafter referred to as—“the site”) hosted on server 232 who wants to subscribe to an authentication service, in accordance with embodiments of the present invention, may register to this service with authentication module 228 (e.g., on a remote server, or at a local device) upon which two personal keys are issued by the authentication module 228 to the site—a site token and a connection token, both unique for that site. The site 233 may receive the keys in a computer executable code, for example:

<script src=″http://securepush.com/cdn/securepush-register.js″
type=″text/JavaScript″></script>
<input type=″hidden″ id=″QVR-SITE-ID″ value=″B3C1211C-758C-
48FF-9010-9AD7C36368D9″ />
<input type=″hidden″ id=″QVR-CONNECTION-TOKEN″
value=″6A17D7D2-708A-42EA-9722-B6F6A7212847″ />
<input type=″hidden″ id=″QVR-LANG″ value=″en″ />

(Examples of two personal codes are indicated in bold characters)

The site 233 may also be provided with a proxy file that facilitates cross-domain display of information from the authentication module 228 on the user's display at his station 220 (e.g., terminal, PC), when browsing to the site 233.

The code may be then embedded in the appropriate page at the site 233 (typically in the registration and log-in pages).

A user, wishing to register to a multi-factor authentication service, is required to have a personal communication device, e.g., handset such as a smartphone 202. Smartphone 202 is operating on and communicating via telecommunication network 204. Installed on smartphone 202 is authentication application 211, which may be a software application, hardware application or a combination of both. Application 211 may be initially installed in smartphone 202 at by the manufacturer of the smartphone, the telecommunication service provider, or downloaded by the user and installed on to the device.

The user may be prompted, upon installing the authentication application 211, to perform an initial registration by providing a few identifying details, such as, for example, a username, a password and an email address. The registration may be verified by sending a confirmation to the email address that was provided by the user, thus facilitating retrieval of the password by the user at a later time, if the password is forgotten. During the registration process the smartphone is registered by sending a mobile equipment identity information 212, which is embedded in smartphone 202, and distinctly and uniquely identifies the handset.

When the user visits site 233 to which authenticated access is required, hosted on server 232, by accessing the site by a local station (e.g., terminal, PC) 220, over communication network 224 (e.g., the Internet), the user may first register to the site by selecting a username and password (preferably not the same ones that the user has used for registering with the authentication service). The user may then be offered the possibility of registering, or may be required to register to, a multi-factor authentication service, according to some embodiments of the present invention. Upon requesting this service, the site 233, hosted on server 232 communicates the request to authentication module 228 (e.g., over communication network 224). Authentication module 228 may present to the user with an ascription screen 218 (e.g., employing cross-domain technique) on the local display of the user's station 220 in which the two keys that were assigned to the site (e.g., the site token and the connection token, both of which typically are permanent keys), as well as a third user-specific personal key (e.g., attach key, which typically is a temporary key) issued by authentication module 228 at a specific time and which remains valid for a prescribed time, are presented. According to some embodiments of the present invention, the three keys may be presented to the user in the form of a barcode 219. Barcode 219 may be, for example, a one-dimensional bar-code (e.g., linear barcode) or two-dimensional barcode (matrix barcode, such as, for example Quick-Response—QR—code.

The user may be prompted (e.g., using the display 210 of smartphone 202) to point the camera 208 of the smartphone 202 to the ascription screen where barcode 219 is presented by the authentication module 228 at the site 233 (e.g., using cross-domain communication technology), and the image may be acquired (either by the user activating the camera or when the barcode 219 is automatically identified by application 211 on smartphone 202). Application 211 may process the acquired image of barcode 219 to retrieve the three keys and sends the three codes to authentication module 228 over a communication link (typically via the telecommunication network the smartphone is registered to and over the network the site is communicating with, such as the Internet). If the three keys are matched with the keys saved at authentication module 228 than a forth key is generated by authentication module 228 (secret key, which is the ascription key for final ascription of the smartphone to the site) and the attach key and secret key are communicated to the site 233, where they are kept for future reference, associated with the user.

FIG. 2B illustrates authentication of a registered user attempting to perform an action at a site, in accordance with embodiments of the present invention.

The registered user who is trying to perform an action at site 233 (e.g., local or remote site), first supplies the personal identification information with which the user is identified at site 233 (registration information). Then, site 233 may then call for a proxy confirmation screen 250 to be presented by authentication module 228 on the display of station 220, which prompts the user to confirm the action using the smartphone. In other embodiments of the present invention no such confirmation screen 250 is presented on the display of station 220. Site 233 sends to authentication module 228 the site token and connection token as well as the attach token associated with the user requesting authentication at site 233.

Authentication module 228 then sends a temporary key to smartphone 202 for confirmation and the user. Upon being prompted to do so (e.g., using prompted message 252 displayed on display 210 of smartphone 202), the user may then confirm the action. The confirmation message is communicated to authentication module 228, and upon receipt of that confirmation, retrieves the secret token associated with the attach token that was sent by site 233 when requesting the authentication of the user, and sends to the site the secret token allowing the site to verify that the secret token is indeed associated at site 233 with the user.

In accordance with some embodiments of the invention, a method for authenticating the user may include determining a location for one or more of said at least one personal communication device and verifying that that location is within one or more predetermined zones. These zones may include a zone within which the user is supposed or expected to be.

The step of requesting the user to confirm the action and the step of authenticating the user may be subjected to a time limit in some embodiments.

To-date, credit cards are designed to be used by single users only. Even in organizations where transaction authorization is legally required from several executives of that organization, it is impossible to enforce this policy when using credit cards.

Some embodiments of the invention may facilitate the performance of actions that require authorization by more than one user. For example, the present invention may be used to facilitate transactions in bank accounts or in credit cards where an authorization is required from several users.

When a bank issues new credit cards or opens a new bank account to an organization that has an authorization policy requiring more than one authorizing officer to authorize transactions, the bank may, according to some embodiments of the invention, require that each of the authorizing officers that are required to authorize transaction register with their communication devices. For example, each authorizing officer is required to associate himself (or herself) to one or more communication devices.

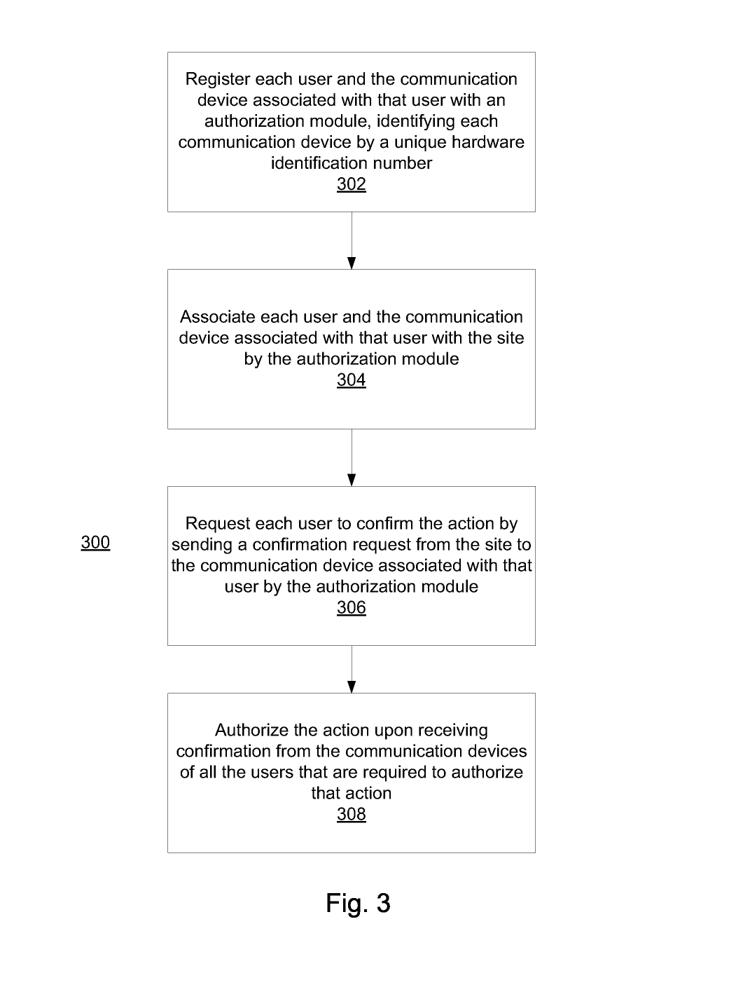

FIG. 3 is a flowchart of a method for authorizing a single action by a plurality of users at a site, in accordance with embodiments of the present invention.

Method 300 may include registering 302 each user and a communication device (one or more) associated with that user with an authorization module, identifying each of the communication devices by a unique hardware identification information. Method 300 may also include associating 304 each of the users and the communication device associated with that user with the site by the authorization module. Method 300 may also include requesting 306 each of the users to confirm the action by sending a confirmation request from the site to the communication device associated with each of the users by the authorization module. Method 300 may further include authorizing 308 the action upon receiving confirmation from the communication devices of all users that are required to authorize that action.

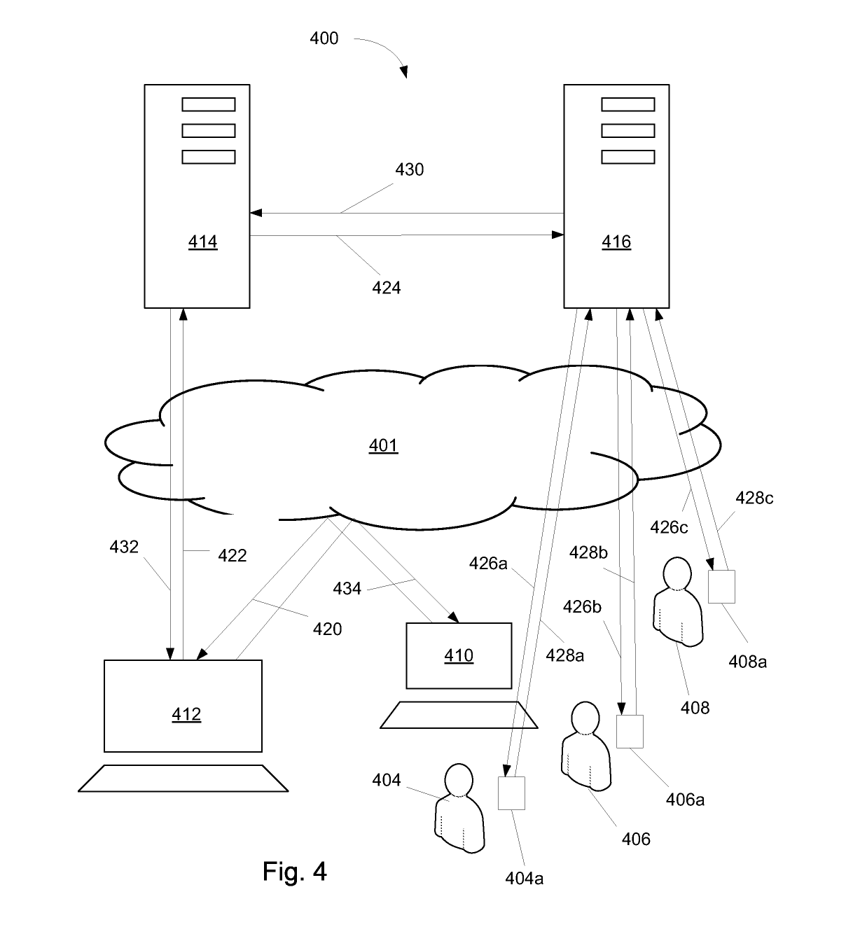

FIG. 4 illustrates a system 400 for authorizing a single action by a plurality of users at a site, in accordance with embodiments of the present invention.

A clearing house 414 (e.g., a credit card clearing house or a banking clearing house) may require that a transaction made on behalf of a client (e.g., a firm, an association, a private person subjected to legal limitations as a minor or a person under custody, etc.) be authorized by a group of persons, such as, for example, partners in a partnership, executives of a firm, a minor and one or two parents of that minor, a person under the custody of one or more custodians and these custodians.

For example, a secretary 404 of a firm and two executives 406 and 408 are required to authorize a transaction with clearing house 414, in order to validate and complete that transaction.

Initially the persons required to authorize an action register with an authorizing service, in accordance with some embodiments of the present invention, by registering themselves and their communication devices, so that each of these persons and one or more communication devices in that person's possession are associated at an authorization module, managing the authorization procedure. The communication devices are identified using the unique hardware identification information uniquely identifying these devices.

For example, the registration methods described hereinabove and in the accompanying figures (see FIG. 2A) may be used.

For example, when opening a bank account or when applying for a credit card, each of the persons required to authorize a transaction, may be required to have a dedicated application be installed on that person's communication device, and associate each person with that person's personal communication devices, for example using a unique QR code that may be presented to each of the persons and acquired by the camera of the personal communication device of that person, similarly to the registration manner described hereinabove. The number of persons required to authorize a transaction and the identities of these persons are recorded and saved.

Clearing house 414 may also register with the authorization service, in accordance with the present invention.

The registration information of the persons (hereinafter—users, 404, 406 and 408) and their associated personal communication devices 404a, 406 and 408a), as well as registration details of the clearing house 414 are saved and used by authorization server 416 (hosting the authorization module managing the authorization method in accordance with embodiments of the present invention).

Secretary 404 may browse using a local station 410 connected over a network 401 to remote shopping site 412. Upon deciding to make a purchase at site 412 the secretary inputs 420 the transaction details, such as, for example, the item to be purchased, shipping method address for deliver and credit card details.

Shopping site 412, communicates 422 the transaction details to clearing house 414, which in turn sends a confirmation request 424 to authorization server 416. Authorization server 416 determines the appropriate persons that are required to authorize the transaction (in this example 404, 406 and 408) and sends a confirmation requests (426a, 426b and 426c) to the personal communication devices (404a, 406a and 408a) associated with these users. Each user may then be prompted by the dedicated application running on his (or hers) personal communication device to confirm the transaction by pressing a key or otherwise input a confirmation. Only when confirmations (428a, 428b and 428c) from all users required to authorize the transaction (e.g., 404, 406 and 408) are received at the authorization server an authorization communication 430 is forwarded to clearing house 414, which then confirms 432 the transaction to shopping site 412. A confirmation message 434 (e.g., an invoice or a receipt) may then be communicated to the secretary station 410.

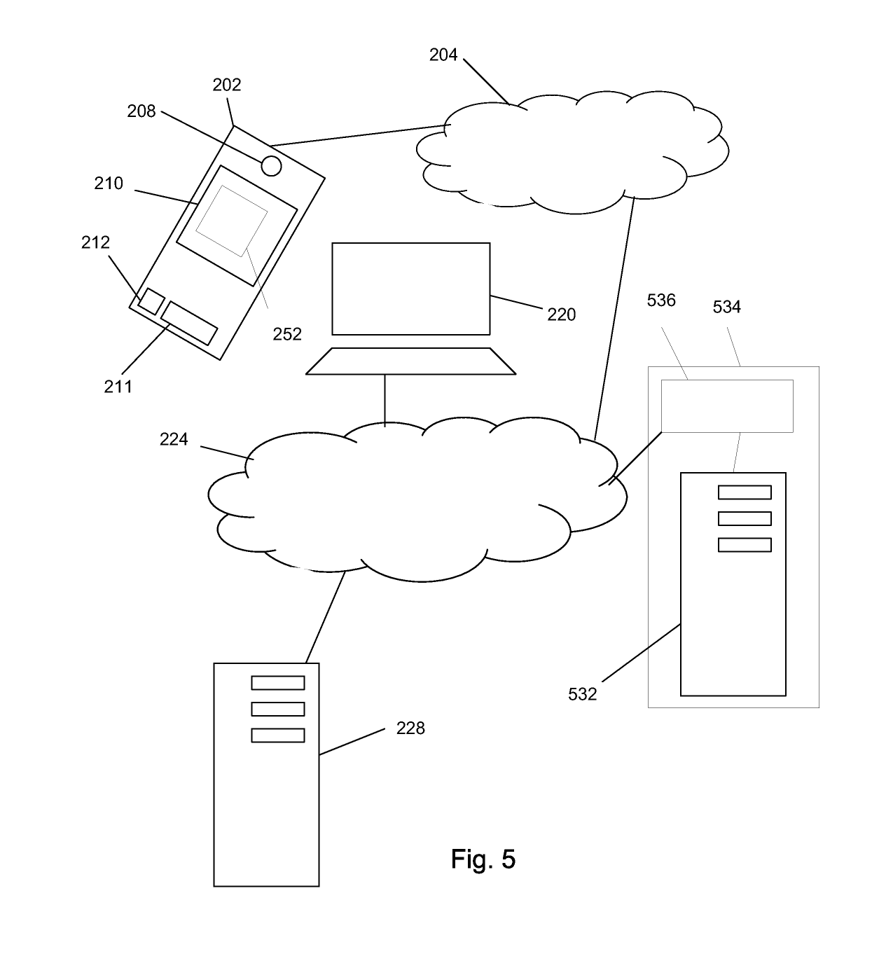

FIG. 5 illustrates authentication of a registered user attempting to access a remote network, in accordance with embodiments of the present invention.

In the example illustrated in FIG. 5, a registered user whose smartphone 202 is registered with authentication server 228, wishes to access a device 532 of remote network 534 using personal computer 220. Switch 536, which is also registered with authentication server 228 and associated with that user and his/hers smartphone 202. The registered user first supplies the personal identification information with which the user is identified at switch 536 (registration information), for example, for performing RDP (remote desktop protocol), FTP (file transfer protocol) actions etc.

Then switch 536 may cause the authentication server 228 to send an authentication request to the user's smartphone 202. Upon providing the confirmation the user's computer 220 is allowed access to device 532 of remote network 534.

In other embodiments of the present invention, no such confirmation screen 250 is presented on the display of station 220. Site 233 sends to authentication module 228 the site token and connection token as well as the attach token associated with the user requesting authentication at site 233.

Authentication module 228 then sends a temporary key to smartphone 202 for confirmation and the user. Upon being prompted to do so (e.g., using prompted message 252 displayed on display 210 of smartphone 202), the user may then confirm the action. The confirmation message is communicated to authentication module 228, and upon receipt of that confirmation, retrieves the secret token associated with the attach token that was sent by site 233 when requesting the authentication of the user, and sends to the site the secret token allowing the site to verify that the secret token is indeed associated at site 233 with the user.

In accordance with some embodiments of the invention, a method for authenticating the user may include determining a location for one or more of said at least one personal communication device and verifying that that location is within one or more zones. These zones may include a zone within which the user is supposed to be.

The step of requesting the user to confirm the action and the step of authenticating the user may be subjected to a time limit in some embodiments, e.g., a time window within which the authentication of the user is completed after the confirmation request was sent to the user's personal communication device.

According to some embodiments of the present invention, a method for authorizing a single action by a plurality of users at a site may include determining the location of one or more of the personal communication devices of the users required to authorize the action and verifying that that location is within one or more zones (e.g., by using the device internal GPS, or other location determination methods). These zones may be, for example, places where the users are known or supposed to be in, such as, for example near the site of the transaction (if the site is a physical point of sale—POS, which is accessed by one or more of the users physically).

According to some embodiments of the present invention, the authorization module may be located on a server remote from the clearing house. In other embodiments, the authorization module may be located on a local server at the clearing house.

According to some embodiments of the invention, the steps of requesting each user to confirm the action and the step of authorizing the action are subjected to a time limit.

Some embodiments of the invention may facilitate the performance of actions that require authorization by a user other than the person who is attempting to perform the action. Such an authorizing user is referred to herein as a guardian. The person who is attempting to perform an action that requires authorization by a guardian is herein referred to as a supervised client.

For example, the present invention may be used to facilitate supervision by a guardian in the form of a parent or other responsible adult over purchases made by a supervised client in the form of a minor or other person requiring supervision. Other examples of supervised clients may include a person who is a compulsive shopper, an addict (e.g., to gambling), a prisoner or parolee, or other person for whom supervision is indicated or desirable.

For example, a guardian may find it convenient to enable a supervised client (e.g., a minor) to make cashless purchase using a credit card or check. On the other hand, the guardian may prefer to authorize some or all of such purchases. Due to various considerations, however, the guardian may prefer that the supervision be remote, discreet, or non-obvious. Such considerations may include, for example, convenience (e.g., the guardian not having to be physically present together with the supervised client), in order to avoid embarrassment to the supervised client, to nurture independence on the part of the supervised client (e.g., minor or other person who is in the process of learning fiscal responsibility), or other considerations. The guardian, therefore, may prefer to be able to remotely authorize the action or purchase rather than be physically present together with the supervised client. When the supervised client is issued a credit card or opens a bank account, the bank may, according to some embodiments of the invention, require that each guardian be registered, together with each guardian's mobile communication devices. For example, each guardian may be required to indicate an association with one or more communication devices.

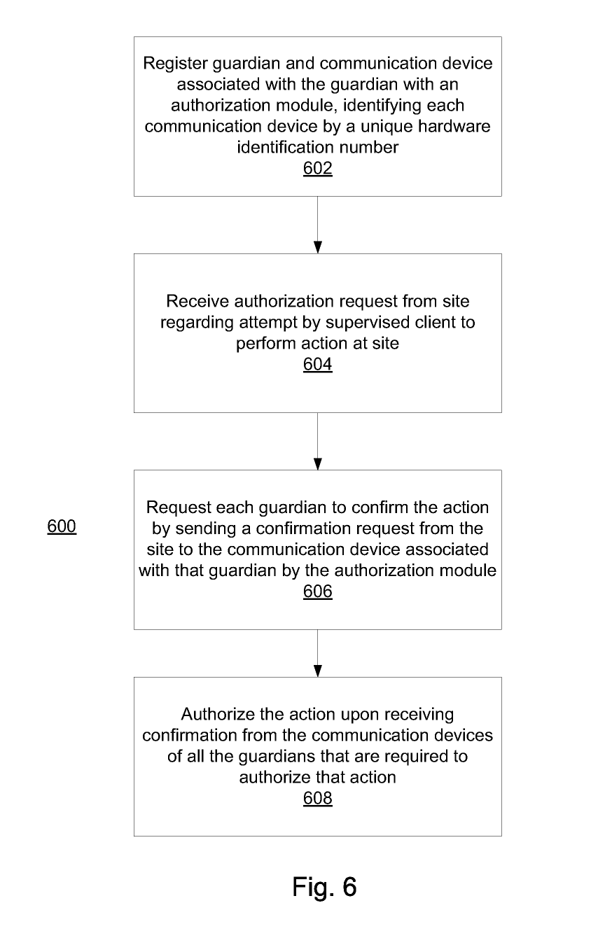

FIG. 6 is a flowchart of a method for guardian control over an electronic action, in accordance with an embodiment of the present invention.

Guardian control method 600 may include registering (block 602) one or a plurality of guardians of a supervised client with an authorization module that is hosted on an authorization server. A communication device (one or more) associated with each guardian is also registered. Each communication device is identified for the purpose of registration (and for later authorization) by unique hardware identification information. In some cases, a mobile communication device that is associated with the supervised client may also be registered.

A site may also be registered with an authorization service, e.g., via a clearing house for credit card or check transactions. A site should be understood to refer to, herein as referring to a website, a point of sale (e.g., credit card reader associated with a store or with a service provider), or other physical or virtual location at which a purchase may be made.

An authorization request may be received from the site by the authorization server (block 604). For example, the site may send an authorization request when the supervised client is detected as attempting to perform a predefined electronic action. For example, action may include placing an order or making a purchase using a credit card, bank account, or other payment method for which guardian authorization is required. In some cases, the authorization request may be submitted by the site to a clearing house. The clearing house may then submit an authorization request to the authorization server. In other cases, the site may submit the authorization request directly to the authorization server. The site may include a website or other remote site, server, computer, or location that the supervised client has contacted from a workstation (e.g., a portable or stationary computer or communications device). The site may include a point of sale (e.g., a credit card reader, cash register, or other point of sale device) at which the supervised client is attempting to make a purchase.

The authorization server requests the guardians of the supervised client to authorize the action (block 606). A confirmation is sent by the authorization module on the authorization server to the registered communication device or devices associated with each guardian of the supervised client. In some cases, a verification request may be sent, in addition, to a communication device that is associated with the supervised client.

When the authorization server receives confirmation of the action from all, or a predetermined portion of, the guardians, the authorization server authorizes the action (block 608). For example, a confirmation authorizing the action may be received from at least one of the mobile communication devices that are associated with each required confirming guardian. Where a verification request was sent to a mobile communication device associated with the supervised client, the supervised client may be requested to verify the action via the supervised client's mobile communication device.

The verification indicates that it is indeed the supervised client who is attempting to per form the action (and does not indicate any form of approval). For example, the verification may indicate the mobile communication device of the supervised client is located at a geographical location from which the action is being attempted (e.g., at a local station of the supervised client, or at a point of sale). In a case where the action is being attempted from the supervised client's mobile communication device (e.g., an online order or purchase), verification from the supervised client's mobile communication device may not be requested or required.

According to an embodiment of the present invention, a time limit is imposed on an authorization request. Thus, for example, if the confirmation of the guardian is received after a predetermined delay limit from the time that the confirmation request was sent, the action is automatically disallowed.

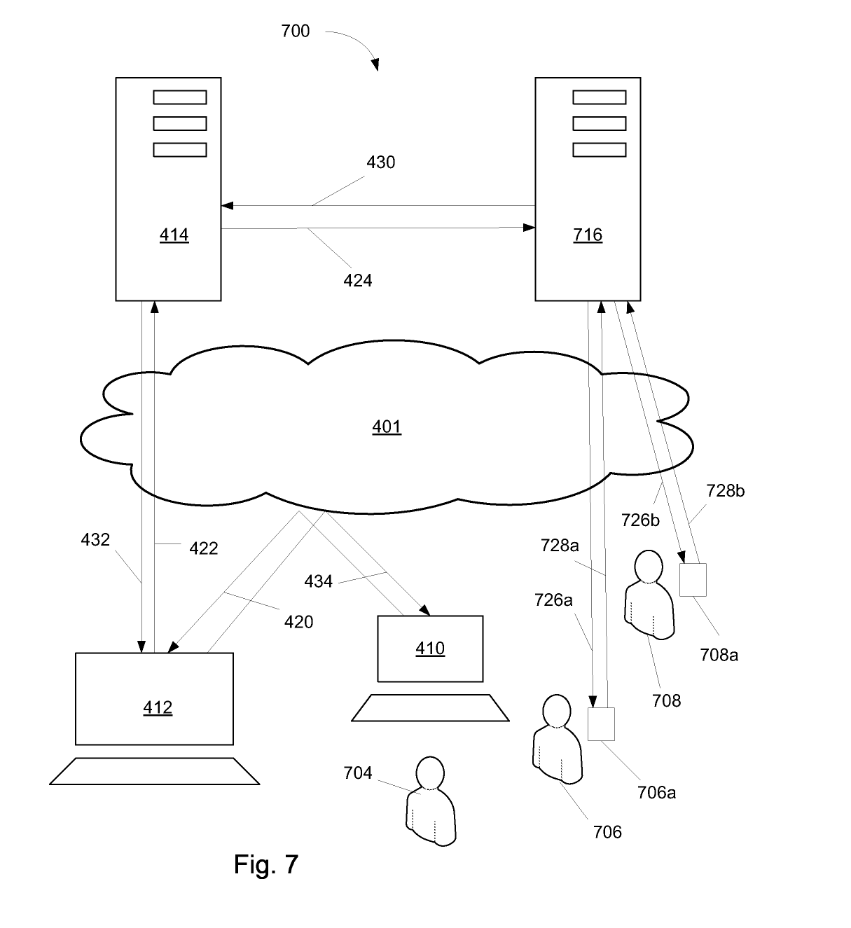

FIG. 7 schematically illustrates a system for guardian control over an electronic action at a remote site by a supervised client, in accordance with an embodiment of the present invention.

Guardian control system 700 includes a clearing house 414 (e.g., a credit card clearing house or a banking clearing house). Guardian control system 700 may require that a transaction made by a supervised client 704 be authorized by one or both of guardians 706 and 708 (or by additional guardians, not shown). For example, supervised client 704 may include a person subjected to legal limitations as a minor or a person under custody, or other person whose electronic actions require guardian authorization. Guardian 706 or 708 may include, for example, a parent, legal guardian, parole officer, person providing treatment, or other person entrusted with authorizing electronic actions by supervised client 704.

For example, supervised client 704 may initiate a transaction (e.g., order or purchase an article or service). One or both of guardians 706 and 708 are required to authorize the transaction with clearing house 414, in order to validate and complete that transaction.

Initially, guardians 706 and 708 register with an authorizing service on authorization server 716 with regard to electronic actions or transactions by supervised client 704. Registration of guardians 706 and 708, in accordance with embodiments of the present invention, may include registering themselves and their communication devices 706a and 708a. Thus, each of guardians 706 and 708 and one or more communication devices 706a and 708a (e.g., in the possession of one of guardians 706 and 708) are associated at an authorization module on authorization server 716 that manages the authorization procedure. Communication devices 706a and 708a are identified using the unique hardware identification information uniquely identifying each communication device 706a or 708a.

For example, when opening a bank account or when applying for a credit card for supervised client 704, each of guardians 706 and 708 may be required to have a dedicated application be installed on each communication device 706a and 708a, and associate each guardian 706 or 708 that guardian's personal communication device 706a or 708a, respectively. The association may include, for example, using a unique QR code that may be presented to each of guardians 706 and 708, and acquired by a camera of each personal communication device 706a or 708a. The number of guardians required to authorize a transaction and the identities of these guardians are recorded and saved.

Clearing house 414 may also register with the authorization service on authorization server 716, in accordance with an embodiment of the present invention.

The registration information of guardians 706 and 708, and their associated personal communication devices 406a and 408a, as well as registration details of the clearing house 414 are saved and used by authorization server 716 (hosting the authorization module managing the authorization method, in accordance with embodiments of the present invention).

Supervised client 704 may browse using a local station 410 connected over a network 401 to remote shopping site 412. Upon deciding to make a purchase at site 412, supervised client 704 inputs 420 the transaction details, such as, for example, the item to be purchased, shipping method address for delivery, and credit card details.

Shopping site 412, communicates 422 the transaction details to clearing house 414, which in turn sends a confirmation request 424 to authorization server 716. Authorization server 716 determines the appropriate guardians that are required to authorize the transaction (in this example, guardians 706 and 708) and sends confirmation requests 726a and 726b to the personal communication devices 706a and 708a associated with guardians 706 and 708. Each guardian 706 or 708 may then be prompted by a dedicated application running that guardian's personal communication device 706a or 708a to confirm the transaction by pressing a key, operating a control or screen control, or otherwise input a confirmation. When confirmations 728a and 728b are received at authorization server 716 from all guardians 706 and 708 that are required to authorize the transaction, authorization communication 430 is forwarded to clearing house 414. Clearing house 414 then confirms 432 the transaction to shopping site 412. Confirmation message 434 (e.g., an invoice or a receipt) may then be communicated to local station 410.

In accordance with an embodiment of the invention, a method for authenticating a guardian 706 or 708 may include determining a location of an associated personal communication device 706a or 708a and verifying that that location is within one or more predetermined zones. The zones may include a zone within which the guardian 706 or 708 is supposed or expected to be.

In accordance with an embodiment of the present invention, a site at which a supervised client attempts an action may include a point of sale.

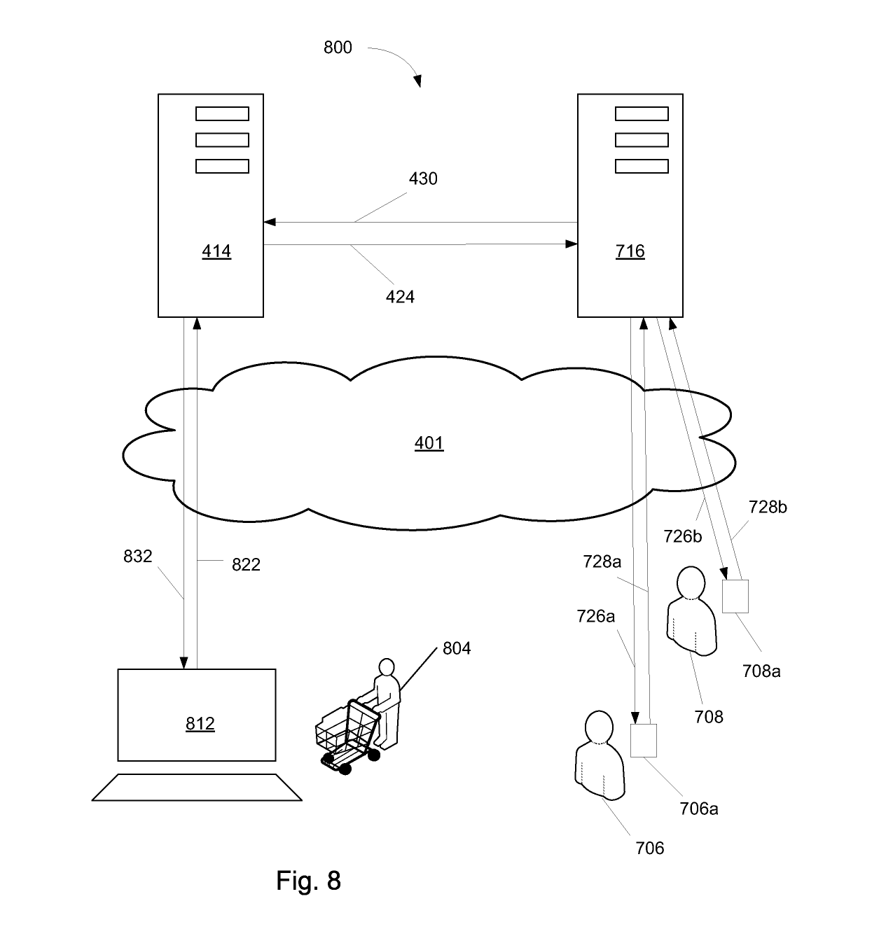

FIG. 8 schematically illustrates a system for guardian control over an electronic action by a supervised client at a point of sale, in accordance with an embodiment of the present invention.

In guardian control system 800, an electronic action in the form of a transaction by a supervised client 804 at point of sale 812 may require authorization by one or both of guardians 706 and 708 (or by additional guardians, not shown). For example, point of sale 812 may include a location at which supervised client 804 is attempting to place an order or make a purchase. Supervised client 804 may attempt to pay at point of sale 12 with a credit card, from a bank account (e.g., check or direct transfer), or in another manner that requires authorization from guardian 706 and 708. For example, a credit card may be read by a credit card reader of point of sale 812.

Upon attempting the action (e.g., attempting to pay for a purchase or order) at point of sale 812, point of sale 812, communicates 822 the transaction details (e.g., item purchased or order, price, or other relevant details) to clearing house 414. Clearing house 414, in turn, sends a confirmation request 424 to authorization server 716. Authorization server 716 determines the appropriate guardians that are required to authorize the transaction (in this example, guardians 706 and 708) and sends a confirmation requests (726a and 726b) to the personal communication devices 706a and 708a associated with guardians 706 and 708. Each guardian 706 or 708 may then be prompted to confirm the transaction. When confirmations 728a and 728b are received at authorization server 716, authorization communication 430 is forwarded to clearing house 414. Clearing house 414 then confirms 832 the transaction to point of sale 812. The attempted action may then be completed (charge made, and order placed or purchased item delivered).

In accordance with an embodiment of the present invention, verification of the action may be further conditioned on verification by a mobile communication device that is associated with the supervised client.

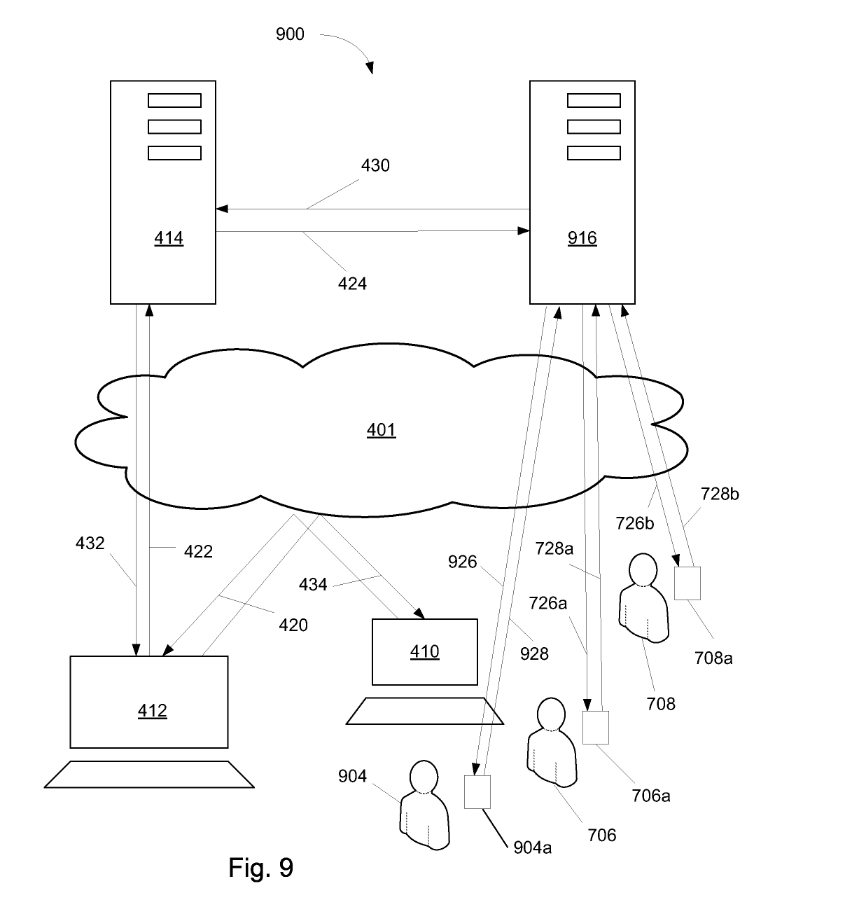

FIG. 9 schematically illustrates a system for guardian control over an electronic action that includes verification by a supervised client, in accordance with an embodiment of the present invention.

Guardian control system 900 may require that a transaction made by a supervised client 904 be authorized by one or both of guardians 706 and 708 (or by additional guardians, not shown). In addition, guardian control system 900 may require verification of the transaction by client mobile device 904a.

For example, supervised client 904 may initiate a transaction (e.g., order or purchase an article or service). One or both of guardians 706 and 708 are required to authorize the transaction with clearing house 414, in order to validate and complete that transaction.

Initially, guardians 706 and 708 register with an authorizing service on authorization server 916, in accordance with some embodiments of the present invention, by registering themselves and their communication devices 706a and 708a. Thus, each of guardians 706 and 708 and one or more communication devices 706a and 708a (e.g., in the possession of one of guardians 706 and 708) are associated at an authorization module on authorization server 916 that manages the authorization procedure. Communication devices 706a and 708a are identified using the unique hardware identification information uniquely identifying each communication device 706a or 708a. In addition, client mobile device 904a may be registered as associated with supervised client 904.

For example, the registration methods described hereinabove and in the accompanying figures (see FIG. 2A) may be used.

For example, when opening a bank account or when applying for a credit card for supervised client 904, each of guardians 706 and 708 may be required to have a dedicated application be installed on each communication device 706a and 708a, and associate each guardian 706 or 708 that guardian's personal communication device 706a or 708a, respectively. The association may include, for example, using a unique QR code that may be presented to each of guardians 706 and 708, and acquired by a camera of each personal communication device 706a or 708a. The number of guardians required to authorize a transaction and the identities of these guardians are recorded and saved.

Similarly, another or the same dedicated application may be installed on client mobile device 904a, in a similar manner.

The registration information of guardians 706 and 708, and their associated personal communication devices 406a and 408a, as well as registration details of the clearing house 414 are saved and used by authorization server 916.

Supervised client 904 may browse using a local station 410 connected over a network 401 to remote shopping site 412. Upon deciding to make a purchase at site 412, supervised client 904 inputs 420 the transaction details, such as, for example, the item to be purchased, shipping method address for delivery, and credit card details. Alternatively or in addition, supervised client 904 may attempt a transaction at a point of sale (such as point of sale 812 in FIG. 8).

Shopping site 412, communicates 422 the transaction details to clearing house 414, which in turn sends a confirmation request 424 to authorization server 916. Authorization server 916 determines the appropriate guardians that are required to authorize the transaction (in this example, guardians 706 and 708) and sends confirmation requests 726a and 726b to the personal communication devices 706a and 708a associated with guardians 706 and 708. Each guardian 706 or 708 may then be prompted by a dedicated application running that guardian's personal communication device 706a or 708a to confirm the transaction by pressing a key, operating a control or screen control, or otherwise input a confirmation. When confirmations 728a and 728b are received at authorization server 916 from all guardians 706 and 708 that are required to authorize the transaction, authorization communication 430 is forwarded to clearing house 414.

Prior to, following, or concurrent with sending confirmation requests 726a and 726b, authorization server 916 may send verification request 926 to client mobile device 904a. Verification 928 may then be sent from client mobile device 904a to authorization server 916.

For example, when verification request 926 to client mobile device 904a, supervised client 904 may be prompted by a dedicated application running on client mobile device 904a to verify the transaction. Verification may include, for example, pressing a key, operating a control or screen control, or otherwise indicate that supervised client 904 is indeed the person who is attempting the transaction. Alternatively or in addition, verification request 926 may request client mobile device 904a to provide or determine a geographic location of client mobile device 904a (e.g., without any action on the part of supervised client 904). For example, verification request 926 may include a geographic location from which the transaction is being requested (e.g., location of local station 410 or of point of sale 812). Verification 928 may then indicate whether or not client mobile device 904a is currently located at or near the requesting location. As another example, verification 928 may include the current location of client mobile device 904a, with authorization sever 916 making the comparison to the requesting location. Geographic location verification may not be required when local station 410 is identical with client mobile device 904a.

When confirmations 728a and 728b and verification 928 are received at authorization server 916, authorization communication 430 is forwarded to clearing house 414. Clearing house 414 then confirms 432 the transaction to shopping site 412. Confirmation message 434 (e.g., an invoice or a receipt) may then be communicated to local station 410.

Aspects of the invention may be embodied in the form of a system, a method or a computer program product. Similarly, aspects of the invention may be embodied as hardware, software or a combination of both. Aspects of the invention may be embodied as a computer program product saved on one or more non-transitory computer readable medium (or mediums) in the form of computer readable program code embodied thereon. Such non-transitory computer readable medium may include instructions that when executed cause a processor to execute method steps in accordance with embodiments of the present invention. In some embodiments of the present invention, the instructions stores on the computer readable medium may be in the form of an installed application and in the form of an installation package.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer, or on a plurality of computers.

Aspects of the invention are described hereinabove with reference to flowcharts and/or block diagrams depicting methods, systems and computer program products according to some embodiments of the invention.

1. A method for guardian control over an electronic action, the method comprising:
registering one or more guardians and at least one mobile communication device associated with each guardian with an authorization module hosted on an authorization server, each of said at least one mobile communication device being identified by a unique hardware identification number;
receiving by the authorization server an authentication request from a site with regard to a supervised client that is attempting to perform the electronic action at the site;
sending a confirmation request from the authorization server to said at least one mobile communication device requesting each guardian of said one or more guardians to confirm the action; and
authorizing the action upon receiving confirmation from at least one device of said at least one mobile communication device that is associated with each said one or more guardians.

2. The method of 1, comprising registering the site with the authorization module.

3. The method of claim 1, comprising installing a dedicated application in said at least one mobile communication device.

4. The method of claim 1, wherein said at least one mobile communication device comprises a cellular telephone.

5. The method of claim 4, wherein the cellular telephone comprises a smartphone.

6. The method of claim 1, further comprising determining a location of said at least one mobile communication device and verifying that the location is within one or more predetermined zones.

7. The method of claim 6, wherein said one or more predetermined zones include a zone within which the guardian with which that mobile communication device is associated is expected to be.

8. The method of claim 1, wherein requesting each guardian to confirm the action or authorizing the action is subjected to a time limit.

9. The method of claim 1, wherein the electronic action comprises a purchase.

10. The method of claim 1, wherein the site comprises a website that is accessed by a local station.

11. The method of claim 1, wherein the site comprises a point of sale.

12. The method of claim 1, further comprising registering at least one client mobile device associated with the supervised client, each of said at least one client mobile device being identified by a unique hardware identification number; and
sending a verification request from the authorization server to said at least one client mobile device;
wherein authorizing the action is further conditioned upon receiving verification at least one device of said at least one client mobile device.

13. The method of claim 12, wherein the verification request comprises requesting a geographic location of said at least one client mobile device.

14. The method of claim 13, further comprising comparing the geographic location with a location from which the electronic action was attempted.
